(19) United States
(12) Patent Application Publication
(10) Pub. No.: US 2023/0059215 A1
(43) Pub. Date: Feb. 23, 2023

(54) Barrier Coating for Substrate

(71) Applicants: Dow Global Technologies LLC, Midland, MI (US); The Regents of the University of California, Oakland, CA (US)

(72) Inventors: Rahul Sharma, Pearland, TX (US); Tamara Dikic, Bergen op Zoom (NL); Ting Xu, Berkeley, CA (US); Aaron Hall, Berkeley, CA (US); Jingyu Huang, Berkeley, CA (US)

(21) Appl. No.: 17/789,691

(22) PCT Filed: Dec. 16, 2020
(86) PCT No.: PCT/US2020/065279

§ 371 Date: Jun. 28, 2022

Related U.S. Application Data
(60) Provisional application No. 62/955,742, filed on Dec. 31, 2019.

(51) Int. Cl. C08F 293/00; C09D 153/00; C08F 220/18

(52) U.S. Cl. CPC C08F 293/005; C09D 153/00; C08F 220/1812; C08F 2438/03; B82Y 30/00

(57) ABSTRACT

The present disclosure provides an article. In an embodiment, the article includes a substrate and a coating on the substrate. The coating includes a composition. The composition includes a plurality of nanoparticles, each nanoparticle having a ligand linked to a surface of each nanoparticle. The composition includes a plurality of block copolymers. Each block copolymer includes a linking block and a nonlinking block. The linking block is a random copolymer composed of at least two different monomers. At least one of the monomers is a linking comonomer. The linking comonomer is directly linked to the ligand to form a first microdomain consisting of the linking block, the nanoparticles, and the ligand. The composition further includes a second microdomain consisting of the nonlinking block.

### BACKGROUND

The shelf life of many packaged food items is negatively impacted by exposure to oxygen and water vapor (moisture). Hence, food packaging needs to be designed to provide adequate barrier to the ingress of oxygen and moisture to protect its contents. In flexible packages, especially those utilizing polyolefin-based films, such barrier is realized by incorporating thin layers of materials like aluminum foil, ethylene-vinyl alcohol copolymer and nylon. Amongst these commonly used materials, aluminum foil provides the best barrier performance. However, aluminum foil suffers from drawbacks like opaqueness which prevents the contents of the package to be visible, inability to microwave the package due to the presence of metal and loss of barrier performance upon flexing the package.

A need exists in the flexible food packaging industry for a barrier flexible film that provides the same or better barrier performance as aluminum foil film and also provides translucence/transparency and/or microwave-ability,

### SUMMARY

The present disclosure provides an article. In an embodiment, the article includes a substrate and a coating on the substrate. The coating includes a composition. The composition includes a plurality of nanoparticles, each nanoparticle having a ligand linked to a surface of each nanoparticle. The composition includes a plurality of block copolymers. Each block copolymer includes a linking block and a nonlinking block. The linking block is a random copolymer composed of at least two different monomers. At least one of the monomers is a linking comonomer. The linking comonomer is directly linked to the ligand to form a first microdomain consisting of the linking block, the nanoparticles, and the ligand. The composition further includes a second microdomain consisting of the nonlinking block.

The present disclosure provides a process. In an embodiment, the process includes dissolving a block copolymer in a solvent. The block copolymer includes a linking block and a nonlinking block. The linking block is a random copolymer composed of at least two different monomers, and at least one of the monomers is a linking comonomer. The process includes mixing a plurality of nanoparticles into the solvent to form a liquid nanoparticle composition, each nanoparticle having a ligand attached thereto. The process includes applying the liquid nanoparticle composition to a substrate and subsequently removing the solvent from the liquid nanoparticle composition located on the substrate to form a coating on the substrate. The coating includes a nanoparticle composition wherein the linking monomer is directly linked to the ligand to form a first microdomain consisting of the linking block, the ligand, and the nanoparticles, and a second microdomain consisting of the nonlinking block.

### BRIEF DESCRIPTION OF THE DRAWINGS

FIGS. 1(a), 1(b), 1(c) are transmission electron microscopy (TEM) images of respective inventive examples P8, P9 and P10 PS-b-P(MA-r-LA) nanocompositions containing 2 vol % of 5 nm ZrO₂ NPs after thermal annealing at 150° C. for 48 hr (scale bar: 100 nm). FIG. 1(d) shows the corresponding SAXS profiles of the three nanocompositions P8, P9, and P10 of FIGS. 1(a), 1(b), 1(c).

FIGS. 2(a), 2(b), and 2(c) are TEM images of inventive example P8 PS-b-P(MA-r-LA) containing (a) 1 vol %, (b) 2 vol % and (c) 4 vol % of 5 nm ZrO₂ NPs after thermal annealing at 150° C. for 48 hr (scale bar: 100 nm). FIGS. 2(d) and 2(e) are TEM analyses of NP distribution in the RCP domain of the nanocompositions containing (d) 1 vol % and (e) 2 vol % of NPs. FIG. 2(f) is a TEM image and schematic drawing of the hexagonal arrangement of NPs in the cylindrical nanocomposition with 2 vol % of NPs (PS: blue; RCP: purple; NP: yellow).

FIGS. 3(a), 3(b), 3(c), 2(d) show in situ SAXS profiles of inventive example P8 PS-b-P(MA-r-LA) containing (a) 0 vol %, (b) 1 vol %, (c) 2 vol % and (d) 4 vol % of 5 nm ZrO₂ NPs. The change of FIG. 3(e) periodicity and FIG. 3(f) grain size as a function of annealing temperature in the P8 polymer and nanocomposition.

FIG. 4 is a differential scanning calorimetry (DSC) heating profile of inventive example P8 BCP with a melting temperature at −16° C. and a glass transition temperature ^{˜}95° C.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percents are based on weight and all test methods are current as of the filing date of this disclosure.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be effected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer” and like terms refer to a polymer containing, in polymerized form, a majority weight percent of units derived from ethylene based on the total weight of the polymer. Nonlimiting examples of ethylene-based polymers include low density polyethylene (or “LDPE” that is ethylene homopolymer, or ethylene/α-olefin copolymer comprising at least one C₃-C₁₀ α-olefin, preferably C₃-C₄ that has a density from 0.915 g/cc to 0.940 g/cc and contains long chain branching with broad MWD, typically produced by way of high pressure free radical polymerization), linear low density polyethylene (or “LLDPE”) a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer; LLDPE is characterized by little, if any, long chain branching, in contrast to conventional LDPE; LLDPE has a density from 0.880 g/cc, or 0.890 g/cc, or 0.900 g/cc, or 0.910 g/cc, or 0.915 g/cc, or 0.920 g/cc, or 0.925 g/cc to 0.930 g/cc, or 0.935 g/cc, or 0.940 g/cc), very low density polyethylene (VLDPE), ultra low density polyethylene (ULDPE), medium density polyethylene (or “MDPE”—ethylene homopolymer, or an ethylene/α-olefin copolymer comprising at least one C₃-C₁₀ α-olefin, or a C₃-C₄α-olefin, that has a density from 0.926 g/cc to 0.940 g/cc), high density polyethylene (or “HDPE”) is an ethylene homopolymer or an ethylene/α-olefin copolymer with at least one C₄-C₁₀ α-olefin comonomer, or C₄-C₈ α-olefin comonomer and a density from greater than 0.94 g/cc, or 0.945 g/cc, or 0.95 g/cc, or 0.955 g/cc to 0.96 g/cc, or 0.97 g/cc, or 0.98 g/cc).

“Olefin-based polymer” (interchangeably referred to as “polyolefin”) is a polymer containing, in polymerized form, a majority weight percent of an olefin, for example ethylene or propylene, based on the total weight of the polymer. Non-limiting examples of olefin-based polymers include ethylene-based polymers and propylene-based polymers.

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” is a polymer that contains more than 50 mole percent polymerized propylene monomer (based on the total amount of polymerizable monomers) and, optionally, may contain at least one comonomer.

Unless stated to the contrary, implicit from the context, or customary in the art, all parts and percents are based on weight, and all test methods are current as of the filing date of this application.

### Test Methods

Density is measured in accordance with ASTM D792, Method B. Results are reported in grams per cubic centimeter (g/cc).

The differential scanning calorimetry (DSC) measurements were performed on a TA instrument DSC Q200 with an RCS40 refrigeration unit. The samples (^{˜}3 mg) were loaded into aluminum calorimetry pans, and heated from −20° C. to 140° C. at a heating rate of 5° C./min under Argon atmosphere. Samples were exposed to one full heating and cooling cycle to remove any thermal history before measurement.

Gel Permeation Chromatography (GPC) is used to measure the polymer molecular mass. Number-average (Mn) and weight-average (Mw) molar mass and dispersity (D=Mw/Mn) of copolymers were obtained using an Agilent 1260 Infinity series instrument outfitted with 2 300×7.5 mm columns (1 Agilent PolyPore column, 1 Agilent Resipore column, in series). THF was used as eluent at 1 mL min-1. Polystyrene and polymethylmethacrylate standards were used to calibrate the GPC system. Analyte samples at 2 mg mL⁻¹ were filtered through 0.2 μm polytetrafluoroethylene (PTFE) membranes before injection (20 μL).

¹H NMR. ¹H NMR (nuclear magnetic resonance) is used to characterize polymerization. Pre-polymerization, post polymerization, and precipitated NMR samples were taken for each polymer. ¹H NMR spectra were carried with a Bruker Avance 400 spectrometer (400 MHz) using a 5 mm Z-gradient BBO probe or a Bruker Avance AV 500 spectrometer (500 MHz) using a Z-gradient Triple Broad Band Inverse detection probe. Global monomer conversion was measured on crude reaction mixtures in CDCl₃, using trioxane as an internal standard. Number-average (Mn) and weight-average (Mw) molar mass and dispersity (D=Mw/Mn) of copolymers were obtained from gel permeation chromatography (GPC) carried out using an Agilent 1260 Infinity series instrument outfitted with 2 300×7.5 mm columns (1 Agilent PolyPore column, 1 Agilent Resipore column, in series). THF was used as eluent at 1 mL min-1. PS and PMMA standards were used to calibrate the GPC system. Analyte samples at 2 mg mL⁻¹ were filtered through 0.2 μm polytetrafluoroethylene (PTFE) membranes (VWR) before injection (20 μL).

Oxygen transmission rate was measured in accordance with ASTM D 3985, with results reported in cc-mil/(100 inch²/day).

Small-angle X-ray Scattering (SAXS). Static SAXS measurements of the bulk samples were performed at Advanced Photon Source 8-ID-E in Argonne National Lab with a 1.240 Å (10 keV) X-ray source. In situ SAXS measurements were performed at the synchrotron beamline Advanced Light Source 7.3.3 in Lawrence Berkeley National Lab with a 1.14 Å (10.9 keV) X-ray source. The in situ SAXS samples were heated directly from room temperature to 90° C. at a heating rate of 10° C./min. Then, the samples were further heated from 90° C. to 180° C. at an interval of 10° C. SAXS profiles were taken after the samples were kept at each temperature for 10 min. The 1D SAXS profiles were obtained by circularly averaging the 2D data. Images were plotted as intensities (I) vs. q, where q=(4π/λ) sin(θ), X is the wavelength of the incident X-ray beam, and 20 is the scattering angle.

Transmission Electron Microscope (TEM). Sample imaging was performed on a FEI Tecnai 12 electron microscopy with an accelerating voltage of 120 kV. BCP samples on TEM grids were placed under RuO₄ vapor for 15 min to stain the PS domain. Nanocomposition samples with ZrO₂ NPs were not stained with RuO₄ since it was found the staining agent can degrade ZrO₂ NPs and make it impossible to distinguish the BCP morphologies.

Water vapor transmission rate (WVTR) was measured in accordance with ASTM F 1249, with results reported in g·mil/(100 inch²/day).

### DETAILED DESCRIPTION

The present disclosure provides an article. The article includes a substrate and a coating on the substrate. The coating is composed of a composition. The composition includes a plurality of nanoparticles (NP or NPs) spatially distributed within a plurality of block copolymers (BCP or BCPs). Each nanoparticle has a ligand linked to a surface of each nanoparticle. Each block copolymer includes a linking block (LB) and a nonlinking block (nLB). The linking block is a random copolymer (RCP) composed of at least two different monomers. At least one of the comonomers is a linking comonomer. The linking comonomer is directly linked to the ligand, to form a first microdomain consisting of the linking block, the ligand, and the nanoparticles. The composition further includes a second microdomain consisting of the nonlinking block.

### Substrate

The present article includes a substrate. The substrate is a film or a sheet composed of a polymeric material. In an embodiment, the substrate is a flexible monolayer film or a flexible multilayer film (collectively interchangeably referred to as “film”). The film has a generally consistent and uniform thickness from 0.012 millimeters (mm) (0.5 mils) to 0.254 mm (10 mils). When the substrate is a multilayer film, the multilayer film has from 2, or 3, or 4, or 5 to 6, or 7, or 8, or 9, or more layers. The multilayer film may include one or more: print layers, barrier layers, core layers, tie layers and/or seal layers.

The film (monolayer film or multilayer film) has a facial surface layer. It is understood that when the film is a monolayer film, the facial surface layer is the monolayer film, the monolayer film having two opposing facial surfaces. The facial surface layer is composed of a polymeric material. Nonlimiting examples of suitable polymeric materials for the film facial surface layer include polyolefins (ethylene-based polymer, propylene-based polymer), ethylene-acrylic acid copolymer, ethylene-(meth)acrylic acid copolymer, ethylene-(meth)acrylate copolymer, methyl acrylate, ethyl acrylate, butyl acrylate, 2-ethylhexyl acrylate, ionomer, and blends thereof. As used herein, the use of the term “(meth)” followed by another term such as acrylate refers to both acrylates and methacrylates. For example, the term “(meth)acrylate” refers to either acrylate or methacrylate; the term “(meth)acrylic” refers to either acrylic or methacrylic; and the term “(meth)acrylic acid” refers to either acrylic acid or methacrylic acid.

Nonlimiting examples of suitable polyolefin for the film facial surface includes propylene/α-olefin copolymer (propylene with one or more C₂, C₄-C₈ α-olefin comonomer) and ethylene/α-olefin copolymer (ethylene with one or more C₃, C₄, C₆, C₈ α-olefin comonomer), and combinations thereof.

In an embodiment, the film facial surface layer is composed of a blend of ethylene/α-olefin copolymer and an ethylene/(meth)acrylic acid copolymer. In an further embodiment, the film facial surface layer is composed of a blend of LLDPE and an ethylene/(meth)acrylic acid copolymer.

### Coating

The article includes a coating on substrate. In an embodiment, the coating is in direct contact with the facial surface layer of the film. The term “directly contacts” or “in direct contact with” refers to a layer configuration whereby a first layer is located immediately adjacent to a second layer and no intervening layers or no intervening structures are present between the first layer and the second layer. In a further embodiment, the coating is substantially coextensive with, or is coextensive with, the facial surface layer of the film.

In an embodiment, the facial surface layer is exposed to a surface treatment to promote adhesion between the facial surface layer and the coating. Nonlimiting examples of suitable surface treatment include corona treatment, ozone treatment, plasma treatment, flame treatment, and combinations thereof.

### Composition

The coating is composed of the composition (interchangeably referred to as “nanoparticle composition”). The composition includes a plurality of nanoparticles spatially distributed within a plurality of block copolymers.

The term “nanoparticles,” (NP or NPs) as used herein, refers to a structure in which at least one dimension is on a nanometer scale (nm). The “nanometer scale” is from 1 nm up to less than 1 micron, or from 1 nm to 100 nm, or from 1 to 50 nm. The term “nanoparticles” includes quantum dots, spherical and pseudo-spherical particles, faceted particles, nanorods, nanowires, tetrapods, anisotropic particles, and combinations thereof. Further, the term “nanoparticles” includes single crystal nanoparticles (i.e. nanocrystals), polycrystalline nanoparticles, and amorphous nanoparticles.

In an embodiment, at least one dimension of the nanoparticles is from 1 nm to less than 20 nm, or from 1 nm to less than 10 nm. A mixture of nanoparticles of different shapes and sizes can be employed to minimize the void fraction in the ordered array of nanoparticles. For example, spherical particles of two different diameters can be selected such that the smaller particles have the appropriate size to fill the interstitial voids formed during close packing (for example hexagonal close packing or face centered cubic) of the larger particles.

The nanoparticles can be a metal, a semiconductor, an inorganic material, a ceramic, a magnetic material, a metalchalcogenide, a metal oxide, or a combination thereof. Nonlimiting examples of suitable metal for the nanoparticles include the alkali metals, alkali earth metals, transition metals, post-transition metals and the lanthanides. Alkali metals include Li, Na, K, Rb and Cs. Alkaline earth metals include Be, Mg, Ca, Sr and Ba. Transition metals include Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. Post-transition metals include Al, Ga, In, TI, Ge, Sn, Pb, Sb, Bi, and Po. Lanthanides include La, Ce, Pr, Nd, Pm, Sm, Eu, Gd, Tb, Dy, Ho, Er, Tm, Yb and Lu. It is understood that the metals described above can adopt one or more different oxidation states.

In an embodiment, the nanoparticles are composed of a metal oxide. Nonlimiting examples of suitable metal oxides include oxides of the alkali metals, alkali earth metals, transition metals, post-transition metals and the lanthanides. Alkali metals include Li, Na, K, Rb and Cs. Alkaline earth metals include Be, Mg, Ca, Sr and Ba. Transition metals include Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. Post-transition metals include Al, Ga, In, TI, Ge, Sn, Pb, Sb, Bi, and Po. Lanthanides include La, Ce, Pr, Nd, Pm, Sm, Eu, Gd, Tb, Dy, Ho, Er, Tm, Yb and Lu. It is understood that the metals described above can adopt one or more different oxidation states.

In an embodiment, the nanoparticles are composed of a non-metal oxide like SiO₂. In a further embodiment, the nanoparticles are composed of mixed oxides such as HfO₂:ZrO₂ and TiO₂:ZrO₂.

Each nanoparticle has a ligand linked to a surface of each nanoparticle. A ligand bonds (covalently or non-covalently) to the surface of its respective nanoparticle. The ligand covers the surface (wholly or partially) of each nanoparticle. Nonlimiting examples of suitable ligands include organophosphate, organophosphonate, organophosphite, organophosphine or organophosphine oxide, organocarboxylic acid, organoalcohol, organothiols, organosilane, an alkylsilane or alkylthiol with alkyl group having from 8 carbon atoms to 24 carbon atoms, and combinations thereof. In an embodiment, the ligand is an alkylsilane or an alkylthiol with alkyl group having from 8 carbon atoms to 24 carbon atoms.

The nanoparticle composition includes a plurality of block copolymers. A “block copolymer” is created when two or more polymer molecules of different chemical composition are covalently bonded to each other. Each polymer molecule forms a block segment, wherein the block segment can be (i) the polymerization of a single monomer type or (ii) the polymerization of two or more different comonomers. Nonlimiting examples of suitable monomers for the block copolymer include acrylate, methacrylate, oligo(ethylene glycol) methyl ether acrylate, acrylamide, methacrylamide, styrene, vinyl-pyridine, and vinyl-pyrrolidone, and combinations thereof.

Each block copolymer includes a linking block (LB) and a nonlinking block (nLB). The linking block is a block segment that is a random copolymer composed of at least two different comonomers (i.e., the polymerization of two or more different comonomers). At least one of the monomers of the linking block is a linking comonomer.

The linking comonomer directly links to the ligand to form a first micro-domain consisting of the linking block, the ligand, and the nanoparticles. A “microdomain,” as used herein, is a domain that has at least one microscopic dimension from 1 nm to 10 μm. The composition also includes a second micro-domain consisting of the nonlinking block. The nonlinking block is a block segment composed of polymerized units of a single monomer type (i.e., the polymerization of a single monomer type). The nonlinking block does not include, or is otherwise void of, a linking comonomer. Consequently, the second micro-domain consists only of the polymer units of the single monomer type to the exclusion of nanoparticles and/or ligands.

The linking comonomer directly links to the ligand, to form a first microdomain consisting of the linking block, the ligand, and the nanoparticles. The term “directly linked,” or “directly links,” as used herein, is an interaction between (i) a moiety on the linking comonomer and (ii) a moiety on the ligand. The linking comonomer “directly linked” to the ligand excludes a linkage that requires a third component (such as a bifunctional linking compound, for example), whereby the third component attaches the linking comonomer with the ligand, the third component being different than each of the linking comonomer and the ligand.

The interaction between the linking comonomer and the ligand is a direct attraction between a moiety of the linking comonomer and a moiety of the ligand. The interaction is a Van der Waals interaction, an ionic interaction, a hydrogen bond, a covalent bond, and combinations thereof. The interaction (the direct link between the linking comonomer and the ligand) is strong enough to drive the nanoparticles solely into the first micro-domain formed by the linking block.

In an embodiment, the interaction directly linking the linking comonomer with the ligand is a Van der Waals interaction. Bounded by no particular theory, it is believed that Van der Waals interactions are realized by having long alkyl chains (greater than 6 carbon atoms, or from 8 to 24 carbon atoms) on the ligands attached to nanoparticles and incorporating, into the linking block, linking comonomer(s) with long alkyl side chains (greater than 6 carbon atoms, or from 8 to 24 carbon atoms) that interact with the ligands attached to nanoparticles.

In an embodiment, the interaction directly linking the linking comonomer with the ligand is a hydrogen bond. Hydrogen bonding is realized by having hydrogen-bond donor or hydrogen-bond acceptor groups in the ligand and complimentary hydrogen-bond acceptor or hydrogen-bond donor groups in the side chain of the linking comonomer(s) (in the linking block) that interacts with the ligand. Hydrogen-bond acceptors include, but are not limited to, carbonyls, amines, nitrogen-containing rings such as pyridine, oxygen containing rings such as furan, etc. Hydrogen-bond donors include but are not limited to, OH, NH₂ and SH.

In an embodiment, the interaction directly linking the linking comonomer with the ligand is an ionic interaction. Ionic interactions are realized by having positively or negatively charged groups on the ligand and incorporating linking comonomer(s) containing oppositely charged groups in the linking block that interacts with the ligand. The positively or negatively charged groups can include permanently charged groups like quaternary amine (NH₄⁺) group and sulfonate (SO₄⁻) group or groups that generate charge based on protonation or deprotonation in certain solvents like amine (NH₂) and carboxylic acid (COOH).

In an embodiment, the interaction directly linking the linking comonomer with the ligand is a covalent bond. Covalent bonding is realized by having a reactive group on the ligand and incorporating linking comonomer(s) (in the linking block) with a complimentary reactive group capable of forming a covalent bond with the groups on the ligand in the linking comonomer in the block that interacts with the ligand. Other interactions like pi-pi interactions or hydrophobic interactions between the ligand and the linking comonomer are also possible.

The linking block defines a volume fraction (f_{RCP}) based on the total volume of the nanoparticle composition. The nanoparticles encompass from 1 vol % to 10 vol % based on the total volume of the nanoparticle composition. The BCP self-assembles so that the phase behavior of the first micro-domain exhibits an ordered behavior. Applicant discovered that a f_{RCP} from 0.25 to 0.75 yields an ordered morphology within the nanoparticle composition. Nonlimiting examples of ordered morphologies include lamellae (L), cylinders (C), and mixed-morphologies (M).

The term “lamellae” refers to a structure where the linking and nonlinking blocks of the BCP form alternating layers oriented parallel or perpendicular to the surface of the substrate. The term “cylinders” refer to hexagonally packed cylinders of either block of the BCP embedded within the other block of the BCP, with the cylinders oriented parallel or perpendicular to the surface of the substrate. The term “mixed-morphologies” refers to any combination of lamellae and cylinder morphologies.

In an embodiment, the linking block defines a volume fraction, f_{RCP}, from 0.30 to 0.55 and the linking block exhibits a lamellae morphology in the nanoparticle composition.

In an embodiment, the BCP includes a nLB consisting only of polystyrene block (units of polymerized styrene monomer) and the linking block is a random copolymer which includes at least one acrylate-based monomer. The nLB is void of nanoparticles and the LB includes the acrylate-based comonomer, the nanoparticles, and the ligand. The linking block defines a volume fraction, f_{RCP}, from 0.30 to 0.55. The nanoparticles have at least one dimension from 1 nm to 10 nm. The nanoparticles have a volume percent from 1 vol % to 4 vol % based on total volume of the nanoparticle composition. The linking block exhibits a lamellae morphology in the nanoparticle composition. Nonlimiting examples of suitable acrylate-based monomers include C₁-C₂₄ alkyl acrylates, methyl acrylate, ethyl acrylate, lauryl acrylate, oligo(ethylene glycol) methyl ether acrylate, and combinations thereof.

In an embodiment, the BCP includes a nLB consisting only of polystyrene block (units of polymerized styrene monomer) and the linking block is a random terpolymer consisting of lauryl acrylate/methyl acrylate/oligo(ethylene glycol) methyl ether acrylate. The lauryl acrylate is the linking comonomer. The nLB is void of nanoparticles and the LB includes the lauryl acrylate/methyl acrylate/oligo(ethylene glycol) methyl ether acrylate terpolymer, the nanoparticles, and the ligand. The lauryl acrylate directly links with the ligand. The linking block defines a volume fraction, f_{RCP}, from 0.30 to 0.55. The nanoparticles have at least one dimension from 1 nm to 10 nm. The nanoparticles have a volume percent from 1 vol % to 4 vol % based on total volume of the nanoparticle composition. The linking block exhibits a lamellae morphology in the nanoparticle composition.

In an embodiment, the BCP includes a nLB consisting only of polystyrene block (units of polymerized styrene monomer) and the linking block is a random copolymer consisting of lauryl acrylate/methyl acrylate copolymer. The lauryl acrylate is the linking comonomer. The nLB is void of nanoparticles and the LB includes the lauryl acrylate/methyl acrylate copolymer, the nanoparticles, and the ligand. The lauryl acrylate directly links with the ligand. The linking block defines a volume fraction, f_{RCP}, from 0.30 to 0.55. The nanoparticles have at least one dimension from 1 nm to 10 nm. The nanoparticles have a volume percent from 1 vol % to 4 vol % based on total volume of the nanoparticle composition. The linking block exhibits a lamellae morphology in the nanoparticle composition.

The nanoparticle composition forms a coating in direct contact with the substrate. The coating has a thickness from 0.1 μm, or 0.5 μm, or 1 μm, or 2 μm, or 3 μm, or, 4 μm or 5 μm to 6 μm, or 7 μm, or 8 μm, or 9 μm, or 10 μm. In an embodiment, the coating on the substrate has a thickness from 0.1 μm to 10 μm, or from 0.5 to 10 μm, or from 1 μm to 10 μm, or from 2 μm to 9 μm, or from 3 μm to 8 μm.

In an embodiment, the substrate is a film having a facial surface layer as disclosed above. The film is composed of an olefin-based polymer. The coating is in direct contact with the facial surface layer. The coating is coextensive with, or substantially coextensive with, the facial surface layer. The coating has a thickness from 0.1 μm to 10 μm. The coated film has a water vapor transmission rate from greater than 0 to less than 0.05 g·mil/(100 inch²/day) or from 0.001 to 0.05, or from 0.002 to 0.05, or from 0.005 to 0.05 g·mil/(100 inch²/day).

In an embodiment, the substrate is a film having a facial surface layer. The film is composed of an olefin-based polymer. The coating is in direct contact with the facial surface layer. The coating is coextensive with, or substantially coextensive with, the facial surface. The coating has a thickness from 0.1 μm to 10 μm. The coated film has an oxygen transmission rate from 0 to less than 1 cc·mil/(100 inch²/day), or from greater than 0 to 1 cc·mil/(100 inch²/day), or from 0.005 to less than 0.05 cc·mil/(100 inch²/day).

The present disclosure provides a process for producing the coated substrate. The process includes dissolving the block copolymer in a solvent. The block copolymer is the block copolymer disclosed above and includes a linking block and a nonlinking block. The linking block is a random copolymer composed of at least two different comonomers, and at least one of the monomers is a linking comonomer. The process includes mixing a plurality of nanoparticles into the solvent to form a liquid nanoparticle composition, each nanoparticle having a ligand attached thereto. The process includes applying the liquid nanoparticle composition to a substrate. The process includes removing the solvent from the liquid nanoparticle composition located on the substrate to form a coating on the substrate. The coating includes a nanoparticle composition. The nanoparticle composition of the coating includes the linking comonomer directly linked to the ligand to form a first microdomain consisting of the linking block, the ligand, and the nanoparticles, and a second microdomain consisting of the nonlinking block.

In an embodiment, the process includes dissolving the block copolymer in a solvent that is toluene.

Nonlimiting examples of suitable applying procedures include spray coating, roll coating, brush coating, gravure coating, dip coating, spin coating, slot-die coating, flexographic coating and combinations thereof.

In an embodiment, the process includes removing the solvent by way of evaporating the solvent, heating the liquid coated substrate, subjecting the liquid coated substrate to negative pressure (vacuum), and combinations thereof.

Once the liquid nanoparticle composition is applied to the substrate, the process may include solvent annealing and/or thermal annealing to impart mobility to the nanoparticle composition.

In an embodiment, the substrate is a film having a facial surface layer. The process includes surface treating the facial surface layer of the film. The surface treatment procedure occurs before the applying step. Nonlimiting examples of surface treating procedures include corona treatment, ozone treatment, plasma treatment, flame treatment, and combinations thereof. The process further includes applying the liquid nanoparticle composition to the surface treated facial surface of the substrate.

In an embodiment, the process includes directly contacting the liquid nanoparticle composition with the facial surface layer of the film, and forming a coating in direct contact with the facial surface layer of the film. The process includes forming a coating having a thickness from 0.1 μm to 10 μm. The coating is composed of the nanoparticle composition.

By way of example, and not limitation, some embodiments of the present disclosure are described in detail in the following examples.

### EXAMPLES

Materials used in the examples are provided in Table A below.

TABLE A

| Abbreviation | Material/Properties |
|---|---|
| AIBN | Azobisisobutyronitrile |
| LA | lauryl acrylate (90%) |
| MA | methyl acrylate (99%) |
| NP | Nanoparticles |
| | 1. 5 nm ZrO₂ NPs coated with 8 carbon alkyl ligands were |
| | purchased from Pixelligent |
| | 2. 4 nm Au NPs coated with 18 carbon alkyl ligands |
| | (oleylamine) were synthesized according to a previously |
| | reported method [Dow |
| OEGA | Oligo(ethylene glycol) methyl ether acrylate (Mₙ = 480 Da) |
| RAFT agents | cyanomethyl dodecyl trithiocarbonate and 2- |
| | (dodecylthiocarbonothioylthio)-2-methylpropionic acid |
| solvents | ACS Grade: methanol, isopropanol, toluene. HPLC: |
| | dichloromethane, pentane) were used as received |
| STY, PS | styrene (polystyrene) |

### Nanoparticles

5 nm ZrO₂ NPs coated with 8 carbon alkyl ligands were purchased from Pixelligent. 4 nm Au NPs coated with 8 carbon alkyl ligands (oleylamine) were synthesized according to the method reported in Peng, S.; Lee, Y. M.; Wang, C.; Yin, H. F.; Dai, S.; Sun, S. H., A Facile Synthesis of Monodisperse Au Nanoparticles and Their Catalysis of CO Oxidation. Nano Res 2008, 1 (3), 229-234.

All of the NPs were dispersed in toluene at a concentration of 20 mg/mL before use.

Polymerization reagents and solvents of the highest purity were purchased from Sigma Aldrich unless otherwise noted. Azobisisobutyronitrile (AIBN) was recrystallized from ethanol prior to use. To remove polymerization inhibitors, methyl acrylate (MA) (99%) and styrene (STY) (98%) were cryodistilled, lauryl acrylate (LA) (90%) was dissolved in hexane, washed 3× with 2M NaOH (Fisher), dried using magnesium sulfate, evaporated under reduced pressure, then passed over a column of basic alumina. Oligo(ethylene glycol) methyl ether acrylate (Mₙ=480 Da) (OEGA) was passed over a column of basic alumina. RAFT agents cyanomethyl dodecyl trithiocarbonate and 2-(dodecylthiocarbonothioylthio)-2-methylpropionic acid, 1,3,5-trioxane (TCI), and solvents (ACS Grade: methanol, isopropanol, toluene. HPLC: dichloromethane, pentane) were used as received.

### Synthesis of BCPs.

Polymerization solutions were prepared by mixing the purified monomers, AIBN, RAFT agent (or macro-RAFT agents for BCP extensions), trioxane (internal NMR standard), and solvents in 20 mL glass ampules. These solutions were subjected to four freeze-pump-thaw cycles before the ampules were sealed at 30 mtorr. The polymerizations were held in a 70° C. oven until the samples reached high viscosity (typically 12-24 hours). The ampules were then removed from the oven, cooled in liquid nitrogen, and cracked open. The polymers were precipitated by dropwise addition of the reacted mixture into rapidly stirring anti-solvent (RCP: methanol, PS: methanol or pentane, BCP: methanol or isopropanol). The polymers exhibit varying behavior upon precipitation based on their monomer composition. The PS precipitates as fine powder, while the RCP is a viscous gel. Successfully extended BCPs form powders with a slight tackiness that increases with the RCP fraction. The powders (PS, BCP) were isolated from the anti-solvent using vacuum filtration over a fritted glass filter, washed with ^{˜}100 mL more of anti-solvent, then transferred to a glass vial. For the RCP, the anti-solvent was decanted, then the precipitate was dissolved in minimal dichloromethane, transferred to a vial, and the dichloromethane removed by a gentle stream of nitrogen gas. All samples were then dried under vacuum overnight.

The characteristics of the synthesized PS-b-P(MA-r-LA-r-OEGA) BCPs (where “b” denotes “block”) are listed in Table 1. The characteristics of the synthesized PS-b-P(MA-r-LA) are listed in Table 2. BCPs samples in Table 1 and Table 2 are coded according to the increasing f_{RCP} and the total molecular weight (Mn) of the BCPs. In Table 1, Mn of the BCPs ranges from 40 kg/mol to 90 kg/mol, and f_{RCP} changes from 0.31 to 0.62. The polymer dispersity (D) ranges from 1.09 to 1.29 for the first synthesized block, and from 1.17 to 1.63 for the BCPs. The molar percentage of OEGA in the RCP domain is low and varies from 1 mol % to 5 mol % based on total moles of the RCP. The degree of polymerization (N) is calculated based on the Mₙ of the two blocks and the monomer molar ratio in the RCP block.

TABLE 1
PS-b-P(MA-r-LA-r-OEGA) Block Polymers

| | | | | | RCP Composition | | |
|---|---|---|---|---|---|---|---|
| | PS/RCP | Block | | | Molar Ratio | | |
| Polymer | (kg/mol) | 1 Ð | BCP Ð | f_{RCP} | (MA:LA:OEGA) | N | Morphology |
| P1 | 57.2/26.5 | 1.27 | 1.57 | 0.31 | 50:49:1 | 707 | L |
| P2 | 59.8/30.1 | 1.14 | 1.62 | 0.32 | 50:47.5:2.5 | 759 | L |
| P3 | 58.3/31.9 | 1.17 | 1.63 | 0.32 | 50:45:5 | 817 | L |
| P4 | 32.2/43.6 | 1.18 | 1.17 | 0.57 | 50:49:1 | 574 | C + L |
| P5 | 22.7/30.8 | 1.29 | 1.57 | 0.60 | 50:47.5:2.5 | 407 | M |
| P6 | 15.8/25.7 | 1.09 | 1.30 | 0.61 | 50:49:1 | 312 | C |
| P7 | 15.7/25.7 | 1.09 | 1.20 | 0.62 | 50:49:1 | 310 | C |

L: lamellae;
C: cylinders;
M: mixed morphologies
The RCP block is the first synthesized block in P1, P2, P3, P5, P6 and P7; the PS block is the first synthesized block in P4.

TABLE 2
PS-b-P(MA-r-LA) Block Polymers

| | | First | | | | | |
|---|---|---|---|---|---|---|---|
| | PS/RCP | Block | Total | | RCP Composition | | |
| Polymer | (kg/mol) | Ð | Ð | f_{RCP} | Molar Ratio (MA:LA) | N | Morphology |
| P8 | 17.3/18.2 | 1.17 | 1.33 | 0.51 | 50:50 | 277 | L |
| P9 | 18.3/25.2 | 1.14 | 1.34 | 0.59 | 50:50 | 331 | M |
| P10 | 23.4/35.6 | 1.14 | 1.48 | 0.62 | 50:50 | 443 | C |

Note:
L: lamellae;
C: cylinders;
M: mixed morphologies
The PS block is the first synthesized block in all the three polymers.

Preparation of Bulk BCP+NP Samples for Morphology Determination

Bulk sample was prepared by adding 200 μL of BCP/NP mixture toluene solution into a 1 mL PTFE beaker. NP loading was varied between from 1 vol % and 4 vol % based on the total volume of the BCP+NP. The beaker was covered with a glass slide and left in a fume hood to let the solvent evaporate slowly over two days. The sample was then dried under vacuum for 2 hours to remove any trace amount of solvent residue and followed by thermal annealing at 150° C. in a vacuum oven for 2 days. After annealing, the sample was cooled down naturally to room temperature under vacuum. Thin sectioning of the bulk samples was performed on a Leica EM FC6 cryo-ultramicrotome at −160° C. Thin sections were picked up using saturated sucrose solution in phosphate buffer at pH 7.4 and then transferred to 200-mesh TEM grids followed by DI water rinsing to get rid of sucrose.

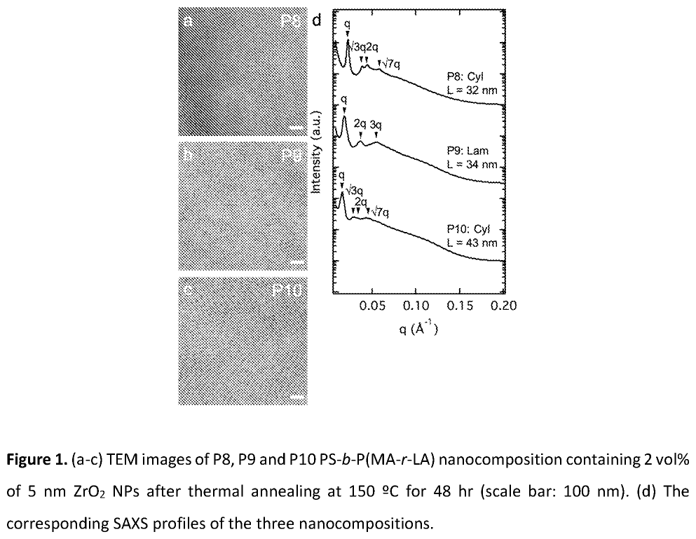

TEM images in FIG. 1a-1c show the assembly of 2 vol % of NPs in P8, P9 and P10 nanocompositions after thermal annealing at 150° C. for 48 hr. NPs are selectively incorporated in the RCP domain with good dispersion. NPs pack into hexagons surrounding the PS cylinders in P8 (FIG. 1a) and P10 (FIG. 1c) nanocompositions. In many regions, NPs cannot fully fill the RCP matrix due to the insufficient quantity. The packing order of NPs in P9 nanocomposition (FIG. 1b) is relatively low with smaller grain sizes, and the NP organization is in complicated morphologies. Based on the SAXS analysis (FIG. 1d), NP assemblies show cylindrical morphology with a periodicity of 32 nm in P8 nanocomposition, lamellar morphology with a periodicity of 34 nm in P9 nanocomposition, and cylindrical morphology with a periodicity of 43 nm in P10 nanocomposition. The addition of NPs expands the periodicities of P9 and P10 slightly from 31 nm to 34 nm and from 41 nm to 43 nm, but expands the periodicity of P8 from 25 nm to 32 nm.

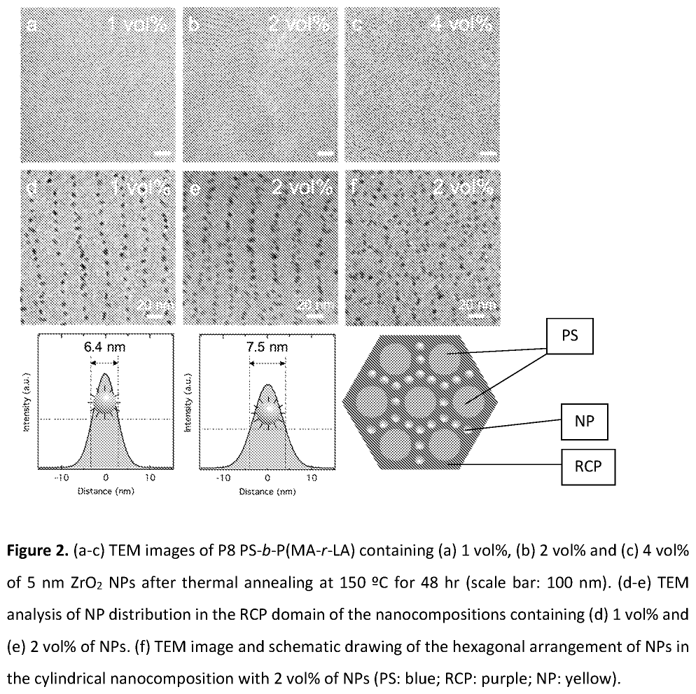

NP loading in P8 nanocomposition was varied from 1 vol % to 4 vol % to further investigate the phase behavior. TEM images in FIG. 2a-2c show P8 nanocompositions after thermal annealing at 150° C. for 48 hr. At 1 vol % particle loading (FIG. 2a), NPs distribute homogeneously in the RCP lamellae, indicating large NP translational entropy in the nanocomposition. NPs form linear arrays in the center of the RCP domain with a periodicity ^{˜}30 nm. The periodicity was measured as the largest distance between two NP arrays based on the TEM images. However, it is hard to identify the nanocomposition morphology due to the low particle loading and the incomplete particle filling. The more apparent order-to-order morphological transition occurs at 2 vol % particle loading, where the nanocomposition forms cylindrical structures with a periodicity of 32 nm (FIG. 2b). The full width at half maximum (FWHM) values of NP distribution across the RCP domain are 6.4 nm and 7.5 nm at 1 vol % and 2 vol % particle loadings, respectively (FIG. 2d-2e). NPs have narrow distribution in the host domain at 1 vol % particle loading, while NPs become less confined in the domain center when the particle loading is increased to 2 vol %. FIG. 2f shows the arrangement of NPs around the hexagonally packed PS cylinders forming hexagonal grids within the RCP domain. No long-range order was observed in nanocomposition with 4 vol % of NPs (FIG. 2c).

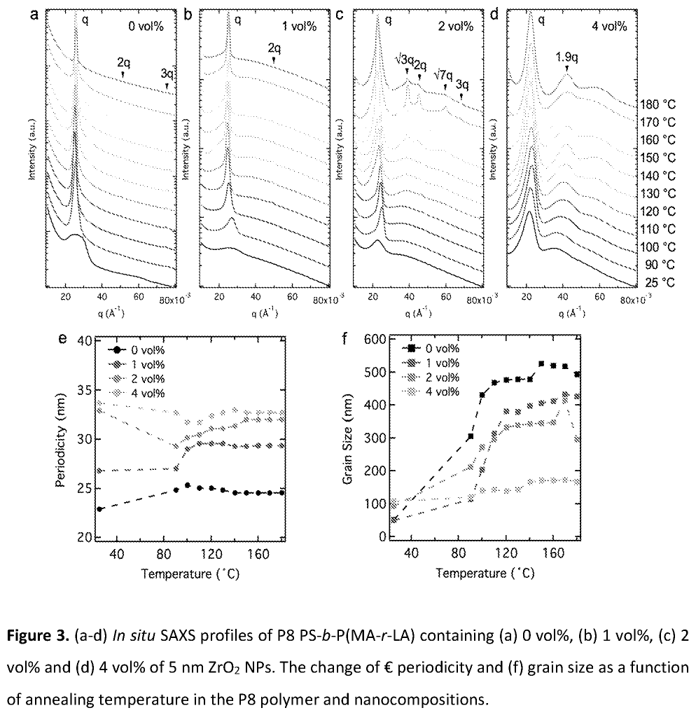

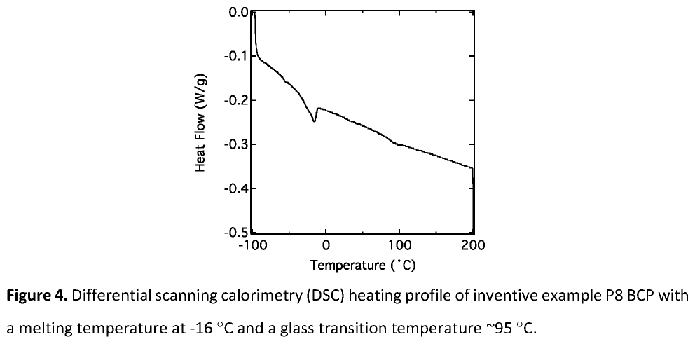

In situ SAXS measurements of P8 BCPs were performed by varying the particle loading from 0 vol % to 4 vol % and the annealing temperature from 90° C. to 180° C. (FIG. 3a-3d). The periodicities of the samples were converted from the q values of the first order peaks in the SAXS profiles (FIG. 3e). The grain sizes of the samples were calculated using the Scherrer equation based on the FWHM of the first order peaks (FIG. 3f). The Scherrer equation is a formula that relates the size of sub-micrometer crystals as disclosed in Smilgies, D. M., Scherrer grain-size analysis adapted to grazing-incidence scattering with area detectors. J Appl Cryst, J Appl Crystallogr 2009, 42, 1030-1034. All the samples at 25° C. before thermal annealing have broad first order peaks and do not show high order peaks, indicating poor order in the samples right after slow solvent evaporation. Based on DSC analysis, T_{g} of the polymer is ^{˜}95° C. (FIG. 4). As the temperature is increased above 90° C., both the periodicities and grain sizes of the samples start to evolve. The periodicities keep almost constant after 150° C., and the grain sizes decrease slightly after 170° C. 150° C. was chosen as the annealing temperatures for all the samples in the current study, since both BCP and nanocomposition show relatively large grain sizes and stable periodicities at this annealing temperature. In P8 BCP (FIG. 3a), high order peaks start to appear ^{˜}110-120° C., indicating a lamellar morphology of the polymer with a periodicity ^{˜}25 nm, consistent with FIG. 3a-3d. At 1 vol % particle loading (FIG. 3b), the nanocomposition periodicity should be 25 nm for lamellar morphology or 30 nm for cylindrical morphology based on the first order peak. The nanocomposition could form cylindrical morphology even at 1 vol % particle loading since the maximum distance between two adjacent NP arrays is ^{˜}30 nm in the TEM image (FIG. 2a).

The incomplete particle filling may explain the absence of V3q peaks indicative of cylindrical structures, and only 2q peaks are present at 110-170° C. At 2 vol % particle loading (FIG. 3c), NPs pack in long-range ordered cylindrical morphology with a periodicity of 32 nm at ^{˜}150-180° C. as indicated by the sharp high order peaks. The results agree well with FIGS. 1b, 1d and 2b. At 4 vol % particle loading, the grain size does not increase much after thermal annealing as indicated by the low order in the TEM image (FIG. 2c). The broad high order peaks reveal poor order in the nanocomposition, probably owing to jammed states at high particle loading in this temperature range.

It is specifically intended that the present disclosure not be limited to the embodiments and illustrations contained herein, but include modified forms of those embodiments including portions of the embodiments and combinations of elements of different embodiments as come within the scope of the following claims.

1. An article comprising:
a substrate;
a coating on the substrate, the coating comprising a composition comprising
a plurality of nanoparticles, each nanoparticle having a ligand linked to a surface of each nanoparticle;
a plurality of block copolymers, each block copolymer comprising a linking block and a nonlinking block;
the linking block is a random copolymer composed of at least two different monomers, and at least one of the monomers is a linking comonomer;
the linking comonomer directly linked to the ligand, to form a first microdomain consisting of the linking block, the nanoparticles, and the ligand, and
a second microdomain consisting of the nonlinking block.

2. The article of claim 1 wherein no nanoparticles are present in the second microdomain.

3. The article of claim 2 wherein the linking block defines a volume fraction (f_{RCP}) based on the total volume of the block copolymers, the linking block having a f_{RCP} from 0.25 to 0.75.

4. The article of claim 3 wherein the nonlinking block is a polystyrene block and the linking block is a random copolymer comprising at least one acrylate-based monomer.

5. The article of claim 4 wherein the random copolymer is a lauryl acrylate/methyl acrylate copolymer and lauryl acrylate is the linking comonomer.

6. The article of claim 4 wherein the random copolymer is a lauryl acrylate/methyl acrylate/oligo(ethylene glycol) methyl ether acrylate terpolymer and lauryl acrylate is the linking comonomer.

7. The article of claim 6 wherein the nanoparticles have at least one dimension from 1 nm to less than 20 nm.

8. The article of claim 7 wherein the composition comprises from 1 vol % to 10 vol % of the nanoparticles based on the total volume of the composition.

9. The article of claim 8 wherein the first microdomain and the second microdomain each has at least one microscopic dimension from 1 nm to 10 μm.

10. The article of claim 9 wherein the substrate is composed of a polymer selected from the group consisting of an olefin-based polymer, an ethylene/(meth)acrylate copolymer, an ethylene/(meth)acrylic acid copolymer, an ionomer, and combinations thereof.

11. The article of claim 10 wherein the substrate is a film having a facial surface;
the coating is in direct contact with the facial surface, the coating having a thickness from 0.1 μm to 10 μm; and
the film has a water vapor transmission rate from greater than 0 to less than 0.05 g·mil/(100 inch²/day).

12. The article of claim 11 wherein the film has an oxygen transmission rate from greater than 0 to less than 1 cc·mil/(100 inch²/day).

13. A process comprising:
dissolving a block copolymer in a solvent, the block copolymer comprising a linking block and a nonlinking block, the linking block is a random copolymer composed of at least two different monomers, and at least one of the monomers is a linking comonomer;
mixing a plurality of nanoparticles into the solvent to form a liquid nanoparticle composition, each nanoparticle having a ligand attached thereto;
applying the liquid nanoparticle composition to a substrate;
removing the solvent from the liquid nanoparticle composition located on the substrate to form a coating on the substrate, the coating comprising
a nanoparticle composition wherein the linking monomer is directly linked to the ligand to form a first microdomain consisting of the linking block, the ligand, and the nanoparticles, and a second microdomain consisting of the nonlinking block.

14. The process of claim 13 wherein the substrate is a film having a facial surface layer, the process comprising
surface treating, before the applying, the facial surface layer of the film; and
applying the liquid nanoparticle composition to the surface treated facial surface layer of the substrate.

15. The process of claim 14 comprising
directly contacting the liquid nanoparticle composition with the facial surface layer of the film; and
forming a coating in direct contact with the facial surface layer, the coating having a thickness from 0.1 μm to 10 μm.
